(19) United States
(12) Patent Application Publication
(10) Pub. No.: US 2024/0430249 A1
(43) Pub. Date: Dec. 26, 2024

(54) REMOTE COLLECTOR-BASED UPDATING OF CLIENT CERTIFICATES IN MONITORED ENDPOINTS

(71) Applicant: VMware LLC, Palo Alto, CA (US)

(72) Inventors: RAHUL SINGH, Bangalore (IN); VINOTHKUMAR D, TamilNadu (IN); VINEETH TOTAPPANAVAR, Bangalore (IN); VENKATA PADMA KAKI, Bangalore (IN); ROHIT SARAF, Haryana (IN)

(21) Appl. No.: 18/232,846

(22) Filed: Aug. 11, 2023

(30) Foreign Application Priority Data
Jun. 23, 2023 (IN) 202341042238

(51) Int. Cl. H04L 9/40; H04L 43/0817

(52) U.S. Cl. CPC H04L 63/0823; H04L 43/0817; H04L 63/20

(57) ABSTRACT

An example method, performed by a remote collector executing on a management node, may include monitoring an endpoint based on a first client certificate. Further, the method may include receiving a request to update the first client certificate in the endpoint. In response to receiving the request, the method may include generating a second client certificate for the endpoint and storing the second client certificate in a storage unit. Furthermore, the method may include applying a control command to the endpoint that causes replacement of the first client certificate with the stored second client certificate in the endpoint. Upon replacing the first client certificate with the second client certificate, the method may include monitoring the endpoint based on the second client certificate.

### RELATED APPLICATIONS

Benefit is claimed under 35 U.S.C. 119(a)-(d) to Foreign Application Serial No. 202341042238 filed in India entitled “REMOTE COLLECTOR-BASED UPDATING OF CLIENT CERTIFICATES IN MONITORED ENDPOINTS”, on Jun. 23, 2023, by VMware, Inc., which is herein incorporated in its entirety by reference for all purposes.

### TECHNICAL FIELD

The present disclosure relates to computing environments, and more particularly to methods, techniques, and systems for updating client certificates in monitored endpoints of a computing environment using a remote collector.

### BACKGROUND

In application/operating system (OS) monitoring environments, a management node that runs a monitoring tool (i.e., a monitoring application) may communicate with multiple endpoints (e.g., virtual computing instances (VCIs)) to monitor the endpoints via a collector appliance (e.g., a cloud proxy). For example, an endpoint may be implemented in a physical computing environment, a virtual computing environment, or a cloud computing environment. Further, the endpoints may execute different applications via virtual machines (VMs), physical host computing systems, containers, and the like. In such environments, the endpoints may send performance data/metrics (e.g., application metrics, operating system metrics, and the like) from an underlying operating system and/or services to the collector appliance. Further, the collector appliance may provide the performance metrics to the monitoring tool for storage and performance analysis (e.g., to detect and diagnose issues).

### BRIEF DESCRIPTION OF THE DRAWINGS

FIG. 1 is a block diagram of an example system, depicting a remote collector to update a client certificate in an endpoint that is being monitored by the remote collector;

FIG. 2 is a block diagram of an example data center, depicting a cloud proxy including a certificate updating script to replace a client certificate in a first endpoint;

FIG. 3 is a sequence diagram illustrating an example sequence of events performed by a remote collector to replace a client certificate in an endpoint;

FIG. 4 is a flow diagram illustrating an example method performed by a remote collector for updating client certificates in monitored endpoints; and

FIG. 5 is a block diagram of an example second endpoint including non-transitory computer-readable storage medium storing instructions to execute a script for replacing a first client certificate with a second client certificate in a first endpoint.

The drawings described herein are for illustrative purposes and are not intended to limit the scope of the present subject matter in any way.

### DETAILED DESCRIPTION

Examples described herein may provide an enhanced computer-based and/or network-based method, technique, and system to update client certificates in monitored endpoints in a computing environment. The paragraphs to present an overview of the computing environment, existing methods to update client certificates, and drawbacks associated with the existing methods.

The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications or software products. Thus, the computing environment may include multiple endpoints such as physical host computing systems, virtual machines, software defined data centers (SDDCs), containers, and/or the like.

Further, performance monitoring of the endpoints has become increasingly important because performance monitoring may aid in troubleshooting (e.g., to rectify abnormalities or shortcomings, if any) the endpoints, provide better health of data centers, analyse the cost, capacity, and/or the like. An example performance monitoring tool or application or platform may be VMware® vRealize Operations (vROps), VMware Wavefront™, Grafana, and the like. Such performance monitoring tools may be used to monitor a datacentre on a private, public, and/or hybrid cloud.

In some examples, the endpoints may include monitoring agents (e.g., Telegraf™, Collectd, Micrometer, and the like) to collect the performance metrics from the respective endpoints and provide, via a network, the collected performance metrics to a remote collector (e.g., a Cloud Proxy (CP)). For example, a monitoring agent such as Telegraf™ agent running in an endpoint may collect metrics from the endpoint and publish them to a metrics receiver. In this example, an Apache HTTPD server serves as the metrics receiver in the CP. The Apache HTTPD server running in the CP may listen on a specific location directive on port 443 to receive the metrics from the Telegraf™ agent.

Further, the remote collector may receive the performance metrics from the monitoring agents and transmit the performance metrics to a monitoring tool or a monitoring application for metric analysis. A remote collector may refer to a service/program that is installed in an additional cluster node (e.g., a virtual machine). The remote collector may allow the monitoring application (e.g., vROps manager) to gather objects into the remote collector's inventory for monitoring purposes. The remote collector collects the data from the endpoints and then forward the data to an application monitoring server that executes the monitoring application. For example, remote collectors may be deployed at remote location sites while the monitoring tool may be deployed at a primary location. In an example, vROps is a multi-node application that can monitor geographically distributed datacentres. In such a distributed environment, remote collectors are installed at cach geo location to monitor and control endpoints at respective datacentres. These remote collectors act as communication medium between master node (i.e., the monitoring application) and the datacentre. Furthermore, the monitoring application may receive the performance metrics, analyse the received performance metrics, and display the analysis in a form of dashboards, for instance. The displayed analysis may facilitate in visualizing the performance metrics and diagnose a root cause of issues, if any.

In such examples, the monitoring application (e.g., vROps) may use the remote collector (e.g., a cloud proxy) to support application and operating system monitoring. The cloud proxy may install the agents on the endpoints to monitor applications and an operating system running in the endpoints. For example, the agents installed on the endpoints may include a monitoring agent (e.g., Telegraf), a supporting agent (e.g., UCP-minion), and a configuration agent (e.g., salt-minion). In an example software-as-a-service (SaaS) platform, the cloud proxy includes a data plane provided by an Apache HTTPD web service via hypertext transfer protocol secure (HTTPS) protocol and a control plane provided via Salt. In such an example SaaS platform, cach endpoint may host the monitoring agent (e.g., Telegraf Agent) for posting application and operating system metrics to the remote collector, the supporting agent for posting service discovery and health metrics to the remote collector, and the configuration agent for receiving control actions from the remote collector. Further, the Telegraf agent and the UCP minion of the data plane may publish metrics to the Apache HTTPD web service running in the cloud proxy. Furthermore, the Salt minion of the control plane may communicate with the Salt master running in the remote collector. Further, control commands such as updating the agents, starting/stopping the agents, and the like may be performed via the Salt minions upon the request of the Salt master.

The remote collector may use Apache httpd service for data plane. The Apache httpd service may use certificate-based Authentication for metrics being posted at the cloud proxy. In this example, as part of agent installation at the endpoint, client certificates or client authentication certificates (e.g., OpenSSL certificate) are placed at the endpoint. Client authentication for metrics being posted from the endpoints to the remote collector is being done by using remote collector's Certificate Authority (CA) certificate and the client certificates placed at the endpoints during agent install operation.

For example, OpenSSL client certificates are generated using server (i.e., cloud proxy) OpenSSL CA certificate. There can be multiple scenarios where client certificates need to be replaced on the endpoints. For example, the client certificate may have to be replaced when the remote collector's Certificate Authority (CA) certificate that generates the client certificate is expired, when the client certificate is expired, when the CA certificate or the client certificate is compromised, when the CA certificate is renewed to a different authority, or the like.

The remote collector may monitor significantly large number of endpoints (e.g., around 4 K endpoints). In this example, for data plane and control plane secure communication, server and client certificate have to be valid. In some existing methods, the client certificate at the endpoints may be changed by manually updating the client certificate at the endpoints. However, expecting end-user to go make these changes manually on every monitored endpoint may be an error prone and cumbersome process and may also affect the user experience. In some other existing methods, the user can reinstall and reconfigure all the endpoints where the certificate has to be changed. However, the agent reinstallation may cause historical data loss. Also, the user may have to provide passwords again to reinstall/reconfigure the agents, which can be a concern.

Examples described herein may provide a remote collector including a script to update a client certificate in endpoints that are being monitored by the remote collector. An example system may include a first endpoint and a second endpoint executing the remote collector. The remote collector may receive metrics of the first endpoint based on a first client certificate and send the received metrics to a monitoring application. In an example, the remote collector may receive a certificate replacement request for the first endpoint. In response to receiving the certificate replacement request, the remote collector may execute the script to generate a second client certificate for the first endpoint, store the second client certificate in a storage unit, and cause a configuration master to replace, via a configuration agent running in the first endpoint, the first client certificate with the second client certificate in the first endpoint. Furthermore, the remote collector may enable the first endpoint to establish a communication with the remote collector based on the second client certificate and to post metrics upon establishing the communication.

The remote collector described herein may use an existing control channel (i.e., the configuration master and the configuration agent) to trigger the changes on the endpoints so that the client certificates get updated. Thus, examples described herein may ensure that the client certificate is replaced without the need to reinstall/reconfigure the endpoints or to manually perform updating of the client certificates on each endpoint.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

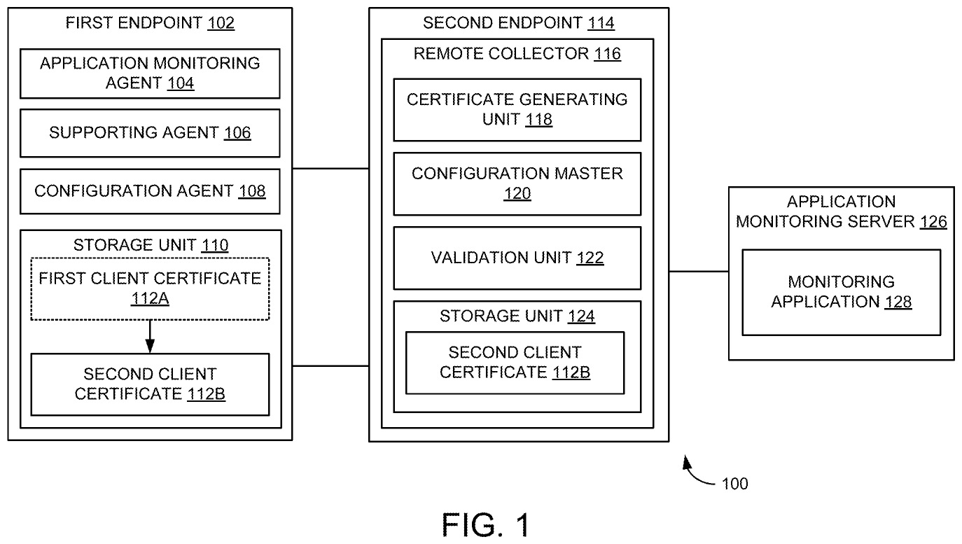

Referring now to the figures, FIG. 1 is a block diagram of an example system 100, depicting a remote collector 116 to update a client certificate in an endpoint (e.g., a first endpoint 102) that is being monitored by remote collector 116. Example system 100 may include a computing environment such as a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications or services or programs. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

As shown in FIG. 1, example system 100 may be a data center that includes multiple endpoints (e.g., first endpoint 102). In an example, an endpoint may include, but not limited to, a virtual machine, a physical host computing system, a container, a software defined data center (SDDC), or any other computing instance that executes different applications. The endpoint can be deployed either on an on-premises platform or an off-premises platform (e.g., a cloud managed SDDC). An SDDC may refer to a data center where infrastructure is virtualized through abstraction, resource pooling, and automation to deliver Infrastructure-as-a-service (IAAS). Further, the SDDC may include various components such as a host computing system, a virtual machine, a container, or any combinations thereof. Example host computing system may be a physical computer. The physical computer may be a hardware-based device (e.g., a personal computer, a laptop, or the like) including an operating system (OS). The virtual machine may operate with its own guest operating system on the physical computer using resources of the physical computer virtualized by virtualization software (e.g., a hypervisor, a virtual machine monitor, and the like). The container may be a data computer node that runs on top of host operating system without the need for the hypervisor or separate operating system.

Further, first endpoint 102 may include an application monitoring agent 104 to monitor applications or services or programs running in first endpoint 102. In an example, application monitoring agent 104 may be installed in first endpoint 102 to fetch the metrics from various components of first endpoint 102. For example, application monitoring agent 104 may real-time monitor first endpoint 102 to collect the metrics (e.g., telemetry data) associated with an application or an operating system running in first endpoint 102. Example application monitoring agent 104 may be a Telegraf agent, Collectd agent, or the like. Example metrics may include performance metric values associated with at least one of central processing unit (CPU), memory, storage, graphics, network traffic, applications, or the like.

Furthermore, first endpoint 102 may include a supporting agent 106 (e.g., a UCP-minion) and a configuration agent 108 (e.g., a salt-minion). For example, supporting agent 106 may obtain service discovery metrics including a list of services running in first endpoint 102. health metrics of application monitoring agent 104, or both. Further, supporting agent 106 may publish metrics to remote collector 116. Configuration agent 108 may receive control commands from a configuration master 120 of remote collector 116. For example, remote collector 116 may perform the control commands such as updating the agents, starting/stopping the agents, and the like on first endpoint 102 via configuration agent 108.

Further, system 100 may include a second endpoint 114 in communication with first endpoint 102. In an example, second endpoint 114 may include a virtual machine, a container, or a physical computing system. In some examples, second endpoint 114 may execute a remote collector 116 (e.g., a cloud proxy (CP) or the like) to receive metrics of endpoints (e.g., first endpoint 102) in the data center. Further, remote collector 116 may send monitored information associated with first endpoint 102 to a monitoring application 128. For example, remote collector 116 may receive the metrics (e.g., performance metrics) of first endpoint 102 from monitoring agent 104. Further, remote collector 116 may transmit the received metrics to monitoring application 128 running in an application monitoring server 126 to analyse the received metrics.

Furthermore, second endpoint 114 may be communicatively connected to first endpoint 102 and application monitoring server 126 via a network. An example network can be a managed Internet protocol (IP) network administered by a service provider. For example, the network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Further, remote collector 116 may include a certificate generating unit 118, a configuration master 120, and a validation unit 122. During operation, certificate generating unit 118 may receive a certificate replacement request for first endpoint 102 (i.e., to replace a first client certificate 112A in first endpoint 102). For example, certificate generating unit 118 may receive the certificate replacement request when a Certificate Authority (CA) certificate that generates first client certificate 112A is expired, first client certificate 112A is expired, when the CA certificate or first client certificate 112A is compromised, or when the CA certificate is renewed to a different authority.

Further during operation, certificate generating unit 118 may generate second client certificate 112B for first endpoint 102. In an example, certificate generating unit 118 may generate second client certificate 112B for first endpoint 102 using a Certificate Authority (CA) certificate. Furthermore, certificate generating unit 118 may store second client certificate 112B in a storage unit 124.

Further, configuration master 120 may replace first client certificate 112A with second client certificate 112B in first endpoint 102. For example, configuration master 120 may run as part of a docker container on second endpoint 114 that executes remote collector 116. In an example, configuration master 120 may replace first client certificate 112A with second client certificate 112B via a configuration agent 108 running in first endpoint 102. In this example, configuration agent 108 may receive a control command from configuration master 120 and execute the command to replace first client certificate 112A with second client certificate 112B in storage unit 110 (e.g., a certificate store).

In an example, configuration master 120 may apply, via configuration agent 108 running in first endpoint 102, a control command to first endpoint 102. The control command, when executed, may stop an agent (e.g., application monitoring agent 104, supporting agent, 106, or both) running in first endpoint 102, download second client certificate 112B from storage unit 124 of remote collector 116 to first endpoint 102, replace first client certificate 112A with downloaded second client certificate 112B, and start the agent on first endpoint 102 to enable the agent to send metrics using replaced second client certificate 112B.

Further, validation unit 122 may establish a communication from first endpoint 102 to remote collector 116 based on second client certificate 112B. Upon establishing the communication, validation unit 122 may enable remote collector 116 to receive the metrics of first endpoint 102. In an example, validation unit 122 may obtain second client certificate 112B from first endpoint 102. Further, validation unit 122 may authenticate first endpoint 102 based on second client certificate 112B and a Certificate Authority (CA) certificate of remote collector 116. Upon authenticating first endpoint 102, validation unit 122 may establish the communication from first endpoint 102 to remote collector 116.

In an example, validation unit 122 may enable remote collector 116 to receive first metrics from application monitoring agent 104 running in first endpoint 102. For example, the first metrics may include performance metrics associated with an operating system, an application, or both running in first endpoint 102. In another example, validation unit 122 may enable remote collector 116 to receive second metrics from supporting agent 106 running in first endpoint 102. For example, the second metrics may include service discovery metrics including a list of services running in first endpoint 102, health metrics of application monitoring agent 104, or both. Thus, examples described herein may provide an approach which can be emulated wherever the certificates need to be replaced on all monitoring endpoints from any virtual appliance (i.e., remote collector 116) monitoring the endpoints without reinstalling and reconfiguring the agents on the endpoints.

In some examples, the functionalities described in FIG. 1, in relation to instructions to implement functions of certificate generating unit 118, configuration master 120, validation unit 122, and any additional instructions described herein in relation to the storage medium, may be implemented as engines or modules including any combination of hardware and programming to implement the functionalities of the modules or engines described herein. The functions of certificate generating unit 118, configuration master 120, and validation unit 122 may also be implemented by a processor. In examples described herein, the processor may include, for example, one processor or multiple processors included in a single device or distributed across multiple devices.

Further, the cloud computing environment illustrated in FIG. 1 is shown purely for purposes of illustration and is not intended to be in any way inclusive or limiting to the embodiments that are described herein. For example, a typical cloud computing environment would include many more remote servers (e.g., endpoints), which may be distributed over multiple data centers, which might include many other types of devices, such as switches, power supplies, cooling systems, environmental controls, and the like, which are not illustrated herein. It will be apparent to one of ordinary skill in the art that the example shown in FIG. 1, as well as all other figures in this disclosure have been simplified for ease of understanding and are not intended to be exhaustive or limiting to the scope of the idea.

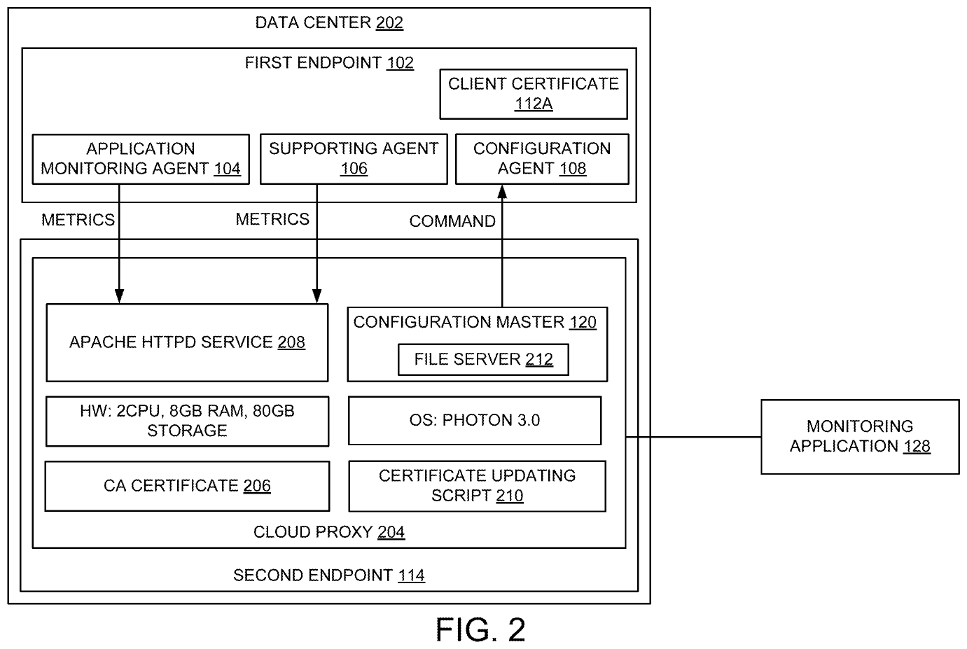

FIG. 2 is a block diagram of an example data center 202, depicting a cloud proxy 204 including a certificate updating script 210 to replace a client certificate in first endpoint 102. For example, similarly named elements of FIG. 2 may be similar in structure and/or function to elements described with respect to FIG. 1. In the example shown in FIG. 2, data center 202 includes first endpoint 102 and second endpoint 114. Further, data center 202 may be communicatively connected to monitoring application 128.

Example first endpoint 102 may include application monitoring agent 104 (e.g., a Telegraf agent) to collect metrics (e.g., application and/or operating system metrics), supporting agent 106 (e.g., a UCP minion agent) for service discovery, and configuration agent 108 (e.g., a Salt minion) for control actions. Further, first endpoint 102 may include client certificate 112A. First endpoint 102 may use client certificate 112A for establishing a secure communication with cloud proxy 204 to post the metrics.

Example second endpoint 114 may include a remote collector. An example remote collector can be a cloud proxy 204, which may run on Photon operating system version 3.0, a processor (e.g., 2 CPU), and a storage (e.g., 80 GB storage). In some examples, cloud proxy 204 may include a data plane and a control plane. For example, the data plane may be provided by an Apache HTTPD service 208 and the control plane may be provided via a Salt master (e.g., configuration master 120 running in second endpoint 114). In another example, the remote collector may be an application remote collector (ARC), which runs on Photon operating system version 1.0. In this example, the data plane may be provided by an EMQTT message broker (e.g., via MQTT Protocol) and the control plane may be provided via the Salt master.

Further, second endpoint 114 may include a Certificate Authority (CA) certificate 206. CA certificate 206 may refer to a certificate for verifying client certificate 112A signed by a CA. Cloud proxy 204 may authenticate client certificate 112A using CA certificate 206. In the example shown in FIG. 2, Apache HTTPD service 208 may use cloud proxy's CA certificate 206 for certificate-based authentication of the metrics posted by first endpoint 102. Thus, the remote collector may use client certificates (e.g., OpenSSL certificates) and keys to secure endpoint communications (e.g., metric communications).

Further, the remote collector may use Salt for control plane activities on first endpoint 102. The Salt may use a server-agent communication model, where a server component is referred to as the Salt master (i.e., configuration master 120) and an agent is referred to as the Salt minion (i.e., configuration agent 108). The salt master may run as part of docker container on second endpoint 114. The Salt master and the Salt minion may secure communication through Salt master keys and Salt minion keys generated at second endpoint 114 on which the remote collector is resided. A Salt state may be applied from the Salt master to the Salt minion to apply control commands on first endpoint 102. The salt master at cloud proxy 204 may host certificates (e.g., files) which can be downloaded by the salt minion at first endpoint 102 when control command is executed using the salt state. For example, the salt file server can be ZeroMQ stateless server. The ZeroMQ stateless server is built into the salt master. Further, the ZeroMQ is an asynchronous messaging library, aimed at use in distributed or concurrent applications. Furthermore, the ZeroMQ sockets provide a layer of abstraction on top of the traditional socket application programming interface (API), which may allow to hide much of the everyday boilerplate complexity. Also, the salt file server may be used for distributing files from master to minions.

In response to receiving a certificate replacement request, cloud proxy 204 may execute certificate updating script 210 for updating client certificate 112A of first endpoint 102 being monitored by cloud proxy 204. In an example, certificate updating script 210 may be hosted at cloud proxy 204, which user may run the script as a one-time activity for client certificates updates on first endpoint 102.

In an example, certificate updating script 210, upon execution, may generate a new client certificate for first endpoint 102 using CA certificate 206 and place the new client certificate in a file server 212 of configuration master 120. Further, certificate updating script 210 may apply the salt state on first endpoint 102 to download the new client certificate from file server 212 to first endpoint and then replace client certificate 112A with the downloaded new client certificate at first endpoint 102.

Upon replacing the client certificate, first endpoint 102 may use the new client certificate to communicate with Apache HTTPD service 208 at cloud proxy 204. In an example, application monitoring agent 104 may post application and operating system metrics to Apache HTTPD service 208 running on cloud proxy 204 using the new client certificate. Similarly, supporting agent 106 may send service discovery (e.g., discovered applications) and health metrics (e.g., health metrics of application monitoring agent 104 and configuration agent 108) to Apache HTTPD service 208 using the new client certificate.

Examples described herein may provide an approach to seamlessly replace a client certificate of first endpoint 102 from cloud proxy 204 through a single script. Thus, all endpoints in a data center being monitored by cloud proxy 204 may automatically be brought to same state at cloud proxy 204 after change of certificate. i.e., same agent's configuration as it was before. Also, without any explicit operation performed by a user at each endpoint for certificate renewal, the agents may authenticate with Apache HTTPD service 208 on cloud proxy 204 and start sending metrics to cloud proxy 204 after script execution. Further, when certificate replacement fails for some endpoints, the script may automatically retry to update only the endpoints which were left to be replaced.

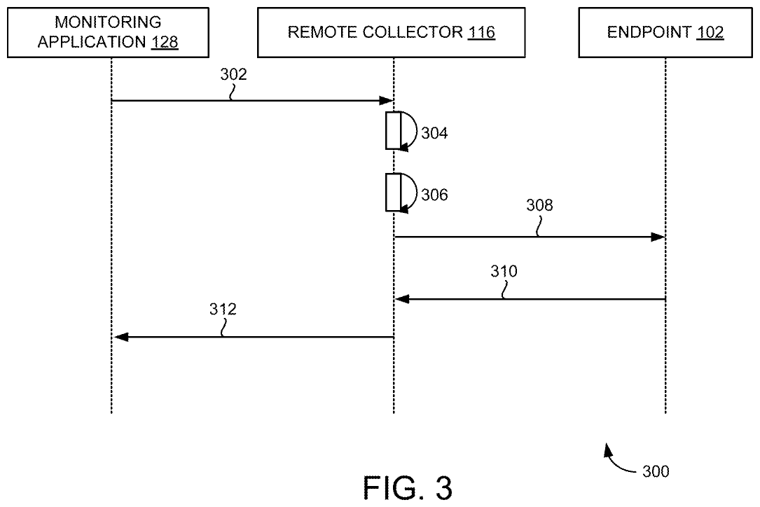

FIG. 3 is a sequence diagram 300 illustrating an example sequence of events performed by a remote collector 116 to replace a client certificate in an endpoint (e.g., first endpoint 102 of FIG. 1). Similarly named elements of FIG. 3 may be similar in structure and/or function to elements described in FIGS. 1 and 2. Sequence diagram 300 may represent the interactions and the operations involved in replacing the client certificate in endpoint 102. FIG. 3 illustrates process objects including monitoring application 128, remote collector 116, and endpoint 102 along with their respective vertical lines originating from them. The vertical lines of monitoring application 128, remote collector 116, and endpoint 102 may represent the processes that may exist simultaneously. The horizontal arrows (e.g., 302, 308, 310, and 312) may represent the data flow steps between the vertical lines originating from their respective process objects (for e.g., monitoring application 128, remote collector 116, and endpoint 102). Further, activation boxes (e.g., 304 and 306) between the horizontal arrows may represent the process that is being performed in the respective process object.

At 302, monitoring application 128 may trigger replacement of the client application in endpoint 102 via remote collector 116. Upon receiving the trigger, at 304, remote collector 116 may execute a script to generate a new client certificate for endpoint 102 monitored by remote collector 116 using a CA certificate of remote collector 116. At 306, remote collector 116 may host generated new certificate to a salt master's file server. At 308, remote collector 116 may apply a salt state to update the client certificate in endpoint 102 with the new client certificate in the file server. At 310, an application monitoring agent (e.g., application monitoring agent 104 of FIG. 1) and a supporting agent (e.g., supporting agent 106 of FIG. 1) in endpoint 102 may send performance metrics of endpoint 102 to Apache HTTPD server (e.g., Apache HTTPD service 208 of FIG. 2) of remote collector 116 using the new client certificate. At 312, remote collector 116 may transmit the performance metrics of endpoint 102 to monitoring application 128 for metrics analysis (e.g., to detect and diagnose issues).

Thus, examples described herein may provide an approach to apply salt state on endpoint 102 to stop the supporting agent and the application monitoring agent on endpoint 102, download the hosted client (e.g., OpenSSL) certificate for endpoint 102 from remote collector 116 to endpoint 102, replace the existing OpenSSL certificate with the newly downloaded certificate, and start the supporting agent and the application monitoring agent on endpoint 102.

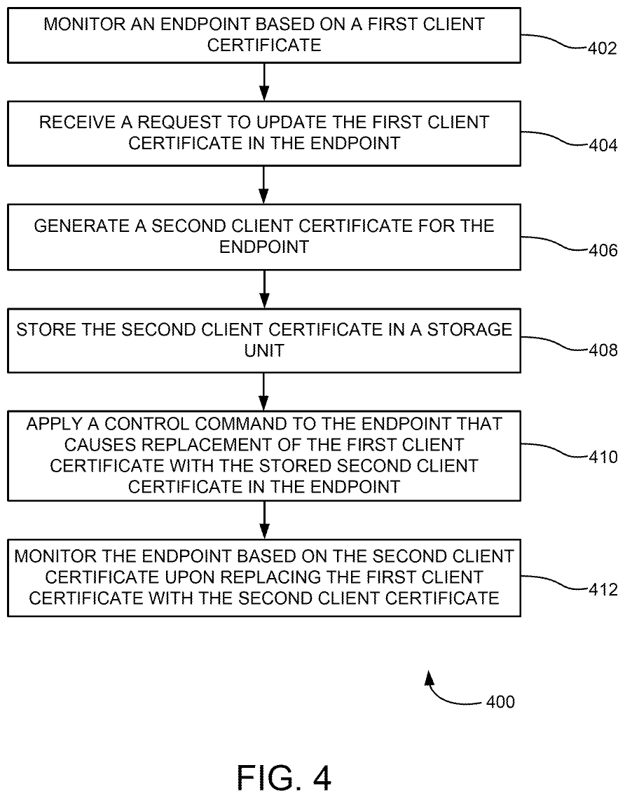

FIG. 4 is a flow diagram illustrating an example method 400 performed by a remote collector for updating client certificates in monitored endpoints. For example, method 400 may be performed by a remote collector executing on a management node. Example method 400 depicted in FIG. 4 represents generalized illustrations, and other processes may be added, or existing processes may be removed, modified, or rearranged without departing from the scope and spirit of the present application. In addition, method 400 may represent instructions stored on a computer-readable storage medium that, when executed, may cause a processor to respond, to perform actions, to change states, and/or to make decisions. Alternatively, method 400 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 402, an endpoint may be monitored based on a first client certificate. At 404. a request to update the first client certificate in the endpoint may be received. In response to receiving the request, at 406, a second client certificate may be generated for the endpoint. At 408, the second client certificate may be stored in a storage unit.

At 410, a control command may be applied to the endpoint that causes replacement of the first client certificate with the stored second client certificate in the endpoint. In an example, applying the control command to the endpoint may include causing a configuration master of the remote collector to apply the control command to the endpoint via a configuration agent running in the endpoint. In this example, the configuration agent may receive the control command from the configuration master and execute the control command to replace the first client certificate with the second client certificate.

In an example, applying the control command to the endpoint may include stopping at least one agent running in the endpoint. For example, the agent may use the first client certificate to send metrics of the endpoint to the remote collector. Further, the stored second client certificate may be downloaded from the storage unit of the remote collector to the endpoint. Furthermore, the first client certificate may be replaced with the downloaded second client certificate. Further, the at least one agent on the endpoint may be started such that the at least one agent is to use the second client certificate to send metrics of the endpoint to the remote collector.

Upon replacing the first client certificate with the second client certificate, at 412, the endpoint may be monitored based on the second client certificate. In an example, monitoring the endpoint based on the second client certificate may include validating the second client certificate received from the endpoint. Further, a trust relationship may be established with the endpoint in response to the validation of the second client certificate. Upon establishing the trust relationship, monitored information of the endpoint may be received.

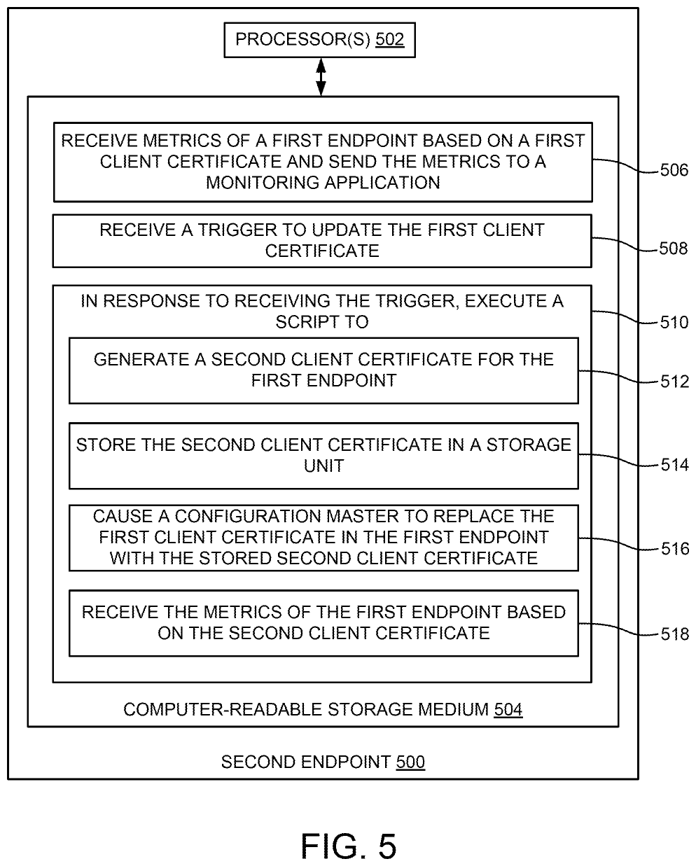

FIG. 5 is a block diagram of an example second endpoint 500 including non-transitory computer-readable storage medium 504 storing instructions to execute a script for replacing a first client certificate with a second client certificate in a first endpoint. Second endpoint 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to second endpoint 500.

Computer-readable storage medium 504 may store instructions 506, 508, 510, 512, 514, 516, and 518. Instructions 506 may be executed by processor 502 to receive metrics of the first endpoint based on the first client certificate and send the received metrics to a monitoring application.

Instructions 508 may be executed by processor 502 to receive a trigger to update the first client certificate. In an example, instructions 508 to receive the trigger to update the first client certificate may include instructions to receive the trigger to update the first client certificate when a Certificate Authority (CA) certificate that generates the first client certificate is expired, the first client certificate is expired, when the CA certificate or the first client certificate is compromised, or when the CA certificate is renewed to a different authority.

In response to receiving the trigger, instructions 510 may be executed by processor 502 to execute a script. During execution of the script, instructions 512 may be executed by processor 502 to generate the second client certificate for the first endpoint. Instructions 514 may be executed by processor 502 to store the second client certificate in a storage unit.

Instructions 516 may be executed by processor 502 to cause a configuration master to replace the first client certificate in the first endpoint with the stored second client certificate. In an example, instructions 516 to cause the configuration master to replace the first client certificate with the stored second client certificate may include instructions to cause the configuration master to replace the first client certificate with the second client certificate via a configuration agent running in the first endpoint. For example, the configuration agent may receive a control command from the configuration master and execute the control command to replace the first client certificate with the second client certificate.

In an example, instructions 516 to cause the configuration master to replace the first client certificate with the stored second client certificate may include instructions to cause the configuration master to apply, via a configuration agent running in the first endpoint, a control command to the first endpoint. The control command may stop an application monitoring agent and a service discovery agent running in the first endpoint, download the stored second client certificate from the storage unit of the remote collector to the first endpoint, replace the first client certificate with the downloaded second client certificate, and start the application monitoring agent and the service discovery agent on the first endpoint to enable the application monitoring agent and the service discovery agent to communicate with the second endpoint based on the replaced second client certificate.

Upon replacing the first client certificate with the second client certificate, instructions 518 may be executed by processor 502 to receive the metrics of the first endpoint based on the second client certificate. In an example, instructions 518 to receive the metrics of the first endpoint based on the second client certificate may include instructions to receive first metrics from an application monitoring agent running in the first endpoint based on the second client certificate. For example, the first metrics may include performance metrics associated with an operating system, an application, or both running in the first endpoint.

In another example, instructions 518 to receive the metrics of the first endpoint based on the second client certificate may include instructions to receive second metrics from a supporting agent running in the first endpoint based on the second client certificate. For example, the second metrics may include service discovery metrics including a list of services running in the first endpoint, health metrics of the monitoring agent, or both.

In an example, instructions 518 to receive the metrics of the first endpoint based on the second client certificate may include instructions to obtain the second client certificate from the first endpoint, validate the first endpoint based on the second client certificate and a Certificate Authority (CA) certificate, and establish a communication from the first endpoint to the second endpoint to receive the metrics of the first endpoint upon validating the first endpoint.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A system comprising:
a first endpoint; and
a second endpoint executing a remote collector, wherein the remote collector is to receive metrics of the first endpoint based on a first client certificate and send the received metrics to a monitoring application, the remote collector comprising:
a certificate generating unit to:
receive a certificate replacement request for the first endpoint;
generate a second client certificate for the first endpoint; and
store the second client certificate in a storage unit;
a configuration master to:
replace the first client certificate with the second client certificate in the first endpoint; and
a validation unit is to:
establish a communication from the first endpoint to the remote collector based on the second client certificate; and
upon establishing the communication, enable the remote collector to receive the metrics of the first endpoint.

2. The system of claim 1, wherein the validation unit is to:
enable the remote collector to receive first metrics from an application monitoring agent running in the first endpoint, wherein the first metrics comprise performance metrics associated with an operating system, an application, or both running in the first endpoint.

3. The system of claim 2, wherein the validation unit is to:
enable the remote collector to receive second metrics from a supporting agent running in the first endpoint, wherein the second metrics comprise service discovery metrics including a list of services running in the first endpoint, health metrics of the application monitoring agent, or both.

4. The system of claim 1, wherein the configuration master is to:
replace the first client certificate with the second client certificate via a configuration agent running in the first endpoint, wherein the configuration agent is to receive a control command from the configuration master and execute the command to replace the first client certificate with the second client certificate.

5. The system of claim 1, wherein the configuration master is to apply, via a configuration agent running in the first endpoint, a control command to the first endpoint to:
stop an agent running in the first endpoint;
download the second client certificate from the storage unit of the remote collector to the first endpoint;
replace the first client certificate with the downloaded second client certificate; and
start the agent on the first endpoint to enable the agent to send metrics using the replaced second client certificate.

6. The system of claim 1, wherein the certificate generating unit is to:
generate the second client certificate for the first endpoint using a Certificate Authority (CA) certificate.

7. The system of claim 1, wherein the validation unit is to:
obtain the second client certificate from the first endpoint;
authenticate the first endpoint based on the second client certificate and a Certificate Authority (CA) certificate; and
upon authenticating the first endpoint, establish the communication from the first endpoint to the remote collector.

8. The system of claim 1, wherein the configuration master is to run as part of a docker container on the second endpoint that executes the remote collector.

9. The system of claim 1, wherein each of the first endpoint and the second endpoint comprises a virtual machine, a container, or a physical computing system.

10. A non-transitory computer-readable storage medium having instructions executable by a processor of a second endpoint to:
receive metrics of a first endpoint based on a first client certificate and send the metrics to a monitoring application;
receive a trigger to update the first client certificate; and
in response to receiving the trigger, execute a script to:
generate a second client certificate for the first endpoint;
store the second client certificate in a storage unit;
cause a configuration master to replace the first client certificate in the first endpoint with the stored second client certificate; and
upon replacing the first client certificate with the second client certificate, receive the metrics of the first endpoint based on the second client certificate.

11. The non-transitory computer-readable storage medium of claim 10, wherein instructions to receive the metrics of the first endpoint based on the second client certificate comprise instructions to:
receive first metrics of the first endpoint from an application monitoring agent running in the first endpoint based on the second client certificate, wherein the first metrics comprise performance metrics associated with an operating system, an application, or both running in the first endpoint.

12. The non-transitory computer-readable storage medium of claim 11, wherein instructions to receive the metrics of the first endpoint based on the second client certificate comprise instructions to:
receive second metrics of the first endpoint from a supporting agent running in the first endpoint based on the second client certificate, wherein the second metrics comprise service discovery metrics including a list of services running in the first endpoint, health metrics of the monitoring agent, or both.

13. The non-transitory computer-readable storage medium of claim 10, wherein instructions to cause the configuration master to replace the first client certificate with the stored second client certificate comprise instructions to:
cause the configuration master to replace the first client certificate with the second client certificate via a configuration agent running in the first endpoint, wherein the configuration agent is to receive a control command from the configuration master and execute the control command to replace the first client certificate with the second client certificate.

14. The non-transitory computer-readable storage medium of claim 10, wherein the instructions to cause the configuration master to replace the first client certificate with the stored second client certificate, comprise instructions to:
cause the configuration master to apply, via a configuration agent running in the first endpoint, a control command to the first endpoint to:
stop an application monitoring agent and a service discovery agent running in the first endpoint;
download the second client certificate from the storage unit of the remote collector to the first endpoint;
replace the first client certificate with the downloaded second client certificate; and
start the application monitoring agent and the service discovery agent on the first endpoint to enable the application monitoring agent and the service discovery agent to communicate with the second endpoint based on the replaced second client certificate.

15. The non-transitory computer-readable storage medium of claim 10, wherein instructions to receive the metrics of the first endpoint based on the second client certificate comprise instructions to:
obtain the second client certificate from the first endpoint;
validate the first endpoint based on the second client certificate and a Certificate Authority (CA) certificate; and
upon validating the first endpoint, establish a communication from the first endpoint to the second endpoint to receive the metrics of the first endpoint.

16. The non-transitory computer-readable storage medium of claim 10, wherein instructions to receive the trigger to update the first client certificate comprise instructions to:
receive the trigger to update the first client certificate when a Certificate Authority (CA) certificate that generates the first client certificate is expired, the first client certificate is expired, when the CA certificate or the first client certificate is compromised, or when the CA certificate is renewed to a different authority.

17. A method performed by a remote collector executing on a management node, comprising:
monitoring an endpoint based on a first client certificate;
receiving a request to update the first client certificate in the endpoint;
in response to receiving the request, generating a second client certificate for the endpoint;
storing the second client certificate in a storage unit;
applying a control command to the endpoint that causes replacement of the first client certificate with the stored second client certificate in the endpoint; and
upon replacing the first client certificate with the second client certificate, monitoring the endpoint based on the second client certificate.

18. The method of claim 17, wherein monitoring the endpoint based on the second client certificate comprises:
validating the second client certificate received from the endpoint;
establishing a trust relationship with the endpoint in response to the validation of the second client certificate; and
upon establishing the trust relationship, receiving monitored information of the endpoint.

19. The method of claim 17, wherein applying the control command to the endpoint comprises:
causing a configuration master of the remote collector to apply the control command to the endpoint via a configuration agent running in the endpoint, wherein the configuration agent is to receive the control command from the configuration master and execute the control command to replace the first client certificate with the second client certificate.

20. The method of claim 17, wherein applying the control command to the endpoint comprises:
stopping at least one agent running in the endpoint, wherein the at least one agent is to use the first client certificate to send metrics of the endpoint to the remote collector;
downloading the second client certificate from the storage unit of the remote collector to the endpoint;
replacing the first client certificate with the downloaded second client certificate; and
starting the at least one agent on the endpoint such that the at least one agent is to use the second client certificate to send metrics of the endpoint to the remote collector.
